(19) United States
(12) Patent Application Publication
(10) Pub. No.: US 2006/0112123 A1
(43) Pub. Date: May 25, 2006

(54) Spreadsheet user-interfaced business data visualization and publishing system

(75) Inventors: Kyle A. Clark, Santa Cruz, CA (US); Indra J. Heckenbach, Santa Cruz, CA (US)

Correspondence Address: LAW OFFICES OF THOMAS E. SCHATZEL;A Professional Corporation, Suite 240, 16400 Lark Avenue, Los Gatos, CA, 95032-2547, US

(73) Assignee: MACNICA, INC.

(21) Appl. No.: 11/222,183

(22) Filed: Sep. 8, 2005

Related U.S. Application Data
(63) Continuation-in-part of application No. 10/996,773, filed on Nov. 24, 2004.

(51) Int. Cl. G06F 17/00; G06F 7/00

(52) U.S. Cl. 707/101

(57) ABSTRACT

A spreadsheet user-interfaced web-based business data publishing system allows users to input and visualize field data and analytical results with interactive charts through a familiar MS-EXCEL user interface. A plug-in module associated with the user's browser and EXCEL application enables a background, web-services connection over the Internet to a management sub-system which extracts, transforms, and publishes data. Charts are customized using a WYSIWYG interface, and business dashboards are constructed through a simple drag-n-drop process. An account management system is included with access control to protect information security. The system is used for visualizing data managing reports, providing special tools to use SAP data, access Query Cubes in SAP BW, and standard and custom R/3 reports. Once data has been extracted from SAP, it is transformed, merged with other data sources, and published as a dashboard or in a business portal. Its management and configuration functions are suited for enterprise reporting and sharing business data.

### RELATED APPLICATION

This application is a continuation-in-part of U.S. patent application Ser. No. 10/996,773, filed Nov. 25, 2004 by Indra J. HECKENBACH, and titled, BUSINESS DATA VISUALIZATION AND PUBLISHING SYSTEM.

### BACKGROUND OF THE INVENTION

1. Field of the Invention

The present invention relates to business data visualization and publishing systems, and in particular to solutions that have familiar spreadsheet user interfaces.

2. Description of the Prior Art

EXCEL is a popular spreadsheet application program marketed by Microsoft (MS) Corporation and its user-interface (UI) is very familiar to millions of users worldwide. EXCEL is commonly used for data reporting and analysis in businesses. It has limited capabilities to visualize data, publish it to the Web, and share it amongst users.

EXCEL allows other producers to customize and extend its capabilities through the use of plug-in modules. Data entered through the EXCEL front-end interface can then be processed in the background by web servers on the Internet without the user having to learn to use a new business system.

Information has strategic and tactical value, and in business, results information and the insights it provides can translate directly into increased profits. “Data warehousing” pulls together data from many different sources to provide a unified, consistent view of customers, operations, and other aspects of a business. Data warehouses are used to extract information from diverse sources so that a company can get a unified, consistent view of customers, operations, and other aspects of the business. Such data is transformed into useful information using analytical tools. Data can be used to support long-term decision making, and to enable sound business decisions in time-sensitive, tactical areas of the organization. Data warehousing integrates, transforms, consolidates, cleans, and stores data for analysis and interpretation.

Business organizations have adopted Internet technologies to organize their structure, work flow, and business relationships to make their operations more efficient. In particular, these technologies have become instrumental in enabling business organizations to manage the large amounts of data generated each business day.

The data generated by a given business organization is typically stored in various databases across the business organization's information systems. If the data is centrally collected, it may be communicated in a number of different formats and not in real-time. A sort of data normalizer and cache function is used to harmonize the data and make it available to analytical tools and reports.

Data may be queried from a database using a standard application program interface called Structured Query Language (SQL). SQL enables a user to select, insert, delete, update, and find out the location of data, among other data operations. The user may specify SQL statements to manipulate data in a database as part of a relational database management system (RDBMS), which is a program for creating, updating, and administering a relational database. Examples of commercially available RDBMS's include DB2 (IBM Corporation, White Plains, N.Y.), Oracle 9i Database (Oracle Corporation, Redwood Shores, Calif.), and OpenIngres (Computer Associates International, Islandia, N.Y.). Spreadsheet software applications like Microsoft Excel can be used to emulate a RDBMS.

Business organizations often use commercially available RDBMS's to manage databases storing their customer, supplier, and internal data such as accounting and financial information, employees' records, inventory, and legal records, among others.

Additionally, business organizations in industries such as construction and manufacturing may use more specialized RDBMS's to manage activity-based costing data involving various business activities and the determination of costs and cost drivers for each activity. An example of activity-based costing data includes the material and labor costs of a construction unit or the costs generated by a given purchase order or machine use. Commercially-available activity-based costing RDBMS's include Prolog Manager and Prolog Scheduler (Meridian Project Systems, Inc., of Folsom, Calif.), and the OneWorld software package (J.D. Edwards & Company, Denver, Colo.).

SAP (Walldorf, Germany), Business Objects (San Jose, Calif.), Oracle Systems (Redwood Shores, Calif.), IBM ESS Space, and others market sophisticated business analysis and reporting systems for large enterprises. These systems tend to be expensive, and are intended to be used by highly skilled specialists and top-level managers.

Commercial products like SAP Business Intelligence enable the creation and control of data warehouses aligned with business requirements. Users can control, monitor, and maintain data staging and processing using SAP Business Information Warehouse (SAP BW) which supports the processing of large volumes of data within the data warehouse. SAP Business Intelligence allows the extraction, integration, and transformation of data from multiple sources. Such sources can include enterprise resource planning (ERP) systems, customer relationship management (CRM) systems, online exchanges, click-stream data sources, XML data sources, relational databases, etc. Data-cleansing and business rules are included to ensure data quality. SAP Business Intelligence can model an information architecture to match an enterprise wide data warehouse or a distributed environment business structure. It provides information for analysis and at an appropriate level of detail.

The Oracle E-Business Suite comprises transactional and business intelligence applications for customer process management, marketing campaign execution, orders shipments, payments, and other day-to-day business operations. Daily Business Intelligence (DBI) is a set of reporting modules and role-based portal pages that enable senior managers and executives to see an accurate and integrated daily summary of their business. DBI portal pages are designed for CEO, VP of Finance, VP of Operations, and other specific business roles. It provides management summaries, related links, and key performance analytics for each business role. DBI portal pages are tied to underlying reports and other pages with supporting detailed information. Organizations can implement one module, multiple modules, or a complete suite. Such modules can be built using the Oracle9i Developer Suite, and deployed using an Oracle9i Application Server and Oracle9i Database. Oracle9iAS and Oracle9iDS provide an integrated suite of BI tools to access, analyze and share information over the Web, develop custom applications, and consolidate enterprise data into a single data warehouse.

According to information provided on their website, the Oracle9iAS Discoverer is a collection of ad hoc query, reporting, analysis, and Web publishing facilities that provide end users with information access and analytic capabilities. Users create ad hoc queries, reports and graphs, drill up and down on their result set, pivot and sort data, and change the layout by simply dragging and dropping query items. Report builders create their own calculations, conditions, parameters and totals to generate custom reports. Results can be shared with other users, or exported in a wide variety of formats, including spreadsheets and HTML or even in XML to other business intelligence tools such as Oracle9i Reports. Oracle provides tight integration of Discoverer with Oracle9iAS Portal product by enabling users to publish their reports for sharing with other portal users. Oracle9iAS Discoverer provide two web clients, Discoverer Plus for power users, data analysts and report builders to create, modify, format, run or schedule queries; and Discoverer Viewer for end users and data analysts to analyze data, execute reports and graphs created in Discoverer Plus. An IT administration tool, Discoverer Administrator, is used for the initial setup and ongoing maintenance of Discoverer metadata, e.g., for creating and maintaining a business oriented view of data, access control, summary data management, and batch scheduling administration.

An enterprise-reporting tool, Oracle9i Reports, creates reports that can be published in various formats to many destinations. Oracle9i Reports includes native connectivity to the Oracle9i Database and to external data sources such as XML, JDBC and text files. Access to additional data sources can be developed using a set of provides Java (application programming interfaces) API's. A Reports Builder allows report developers to control the placement of objects within each report. Report wizards let developers create and modify report definitions. Both conditional formatting and drill-down capabilities, e.g., via text and graph hyperlinks, can be incorporated into a report. A Reports Graph wizard generates graphs with a variety of graph types, including 3D graphs. Output reports formats supported include Adobe PDF, Postscript, PCL, Word (RTF), Excel (CSV), Intelligent Business Strategies 6 Corporate Performance Optimization Guide.

The commercial Oracle products further include a Java Server Page (JSP) output report facility that lets developers embed report data into their Web pages. Additional output destinations can be developed using a set of provides Java API's. Oracle9i Reports also allows reports to be deployed to an Oracle9iAS portal page. Developers can set up the report to display a static report output page, or have the report run each time the hyperlink is clicked on the portal page.

Oracle9i Warehouse Builder (OWB) is a development environment for modeling, generating, deploying, and managing data warehouses. OWB leverages Oracle9i Database as its ETL engine, and provides wizard-driven user interfaces and predefined transformations to allow ETL processes to be quickly developed and deployed. Facilities provides enable developers to import data source definitions, design and create the target database schema, define and create the data flows between sources and targets, manage and update source definitions and target schema, and design and create the OLAP and ad hoc query environments for an application. The metadata created by OWB is CWM (Common Warehouse Metamodel) compliant, allowing for metadata integration.

The B3 SMART™ product is marketed by Macnica (Yokohama, Japan) as a cost-effective and easy to use solution for visualizing business data. The product is preferably certified for SAP BW integration, and supports SAP Reports, SALESFORCE, SQL, Excel, and other data sources. Using an intuitive web-based interface, data can be extracted, transformed, managed, and published online. The B3 SMART™ product also provides an account management system and role-based access control. The B3 SMART™ product can be used to visualize many types of data. Its management and configuration functions are useful for enterprise reporting and sharing business data. An executive can review high-level business data to monitor corporate performance.

B3 SMART™ is a tool to visualize business logistics, sales data, and other business areas. There are a wide variety of applications, such as inventory management, SCM, SRM, sales data, corporate performance, and so on.

### SUMMARY OF THE INVENTION

Briefly, a spreadsheet user-interfaced web-based business data publishing system embodiment of the present invention allows users to input and visualize field data and analytical results with interactive charts through a familiar MS-EXCEL UI. A plug-in module for EXCEL enables a background, web-services connection over the Internet to a management sub-system which extracts, transforms, and publishes data. ETL functionality is used to extract data from SAP BW, SAP Reports, SForce (SALESFORCE), SQL, XML, Excel, plain text files, and other diverse sources. A transformation engine provides sophisticated data transforms through a menu interface, without relying on programming or scripting. CORDA POPCHART™ is included to generate charts, graphs, and map graphics. Charts are customized using a WYSIWYG interface, and business dashboards are constructed through a simple drag-n-drop process. An account management system is included with access control to protect information security. The system is used for visualizing data managing reports, providing special tools to use SAP data, access Query Cubes in SAP BW, and standard and custom R/3 reports. Once data has been extracted from SAP, it is transformed, merged with other data sources, and published as a dashboard or in a business portal. Its management and configuration functions are suited for enterprise reporting and sharing business data.

An advantage of the present invention is that a business system is provided to visualize data, publish it to the Web, and share it amongst other users.

Another advantage of the present invention is that a familiar spreadsheet user interface is extended with a plug-in module to all a business system server on the Internet to help visualize data, publish it to the Web, and share it amongst other users.

An advantage of the present invention is that a system is provided that analyzes business data to improve strategic decisions.

Another advantage of the present invention is that a system is provided that publishes data to improve communication and collaboration.

A further advantage of the present invention is that a system is provided to extract data from business application software, databases, and other sources.

A still further advantage of the present invention is that a system is provided that generates rich charts, graphs, and maps for enhanced visualization.

Another advantage of the present invention is that a system is provided to build web sites, portals, and dashboard using a drag-n-drop interface, and to manage resources using a convenient and intuitive web-based interface. This system is particularly unique in that it supports any HTML templates without modification, and does not utilize custom tags.

Another advantage of the present invention is that a system is provided to normalize, prepare, and convert data into a form suitable for visualization.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a business data visualization and publishing system embodiment of the present invention with an EXCEL plug-in to implement a spreadsheet user interface;

FIG. 2 is a functional block diagram of a business data visualizer embodiment of the present invention, as shown as a component in the system of FIG. 1.

FIG. 3 is a business intelligence system embodiment of the present invention;

FIG. 4 is a functional block diagram of a BW access adapter embodiment of the present invention;

FIG. 5 is a UML class diagram of a B3 prototype system organized in three tiers representing data, business, and web;

FIG. 6 is a UML class diagram of A B3 system 200 which included several common classes to aid other layers of the application; and

FIG. 7 is a UML class diagram of a B3 system Common: Table with classes that are used for an internal representation of data.

### DETAILED DESCRIPTION OF THE PREFERRED EMBODIMENT

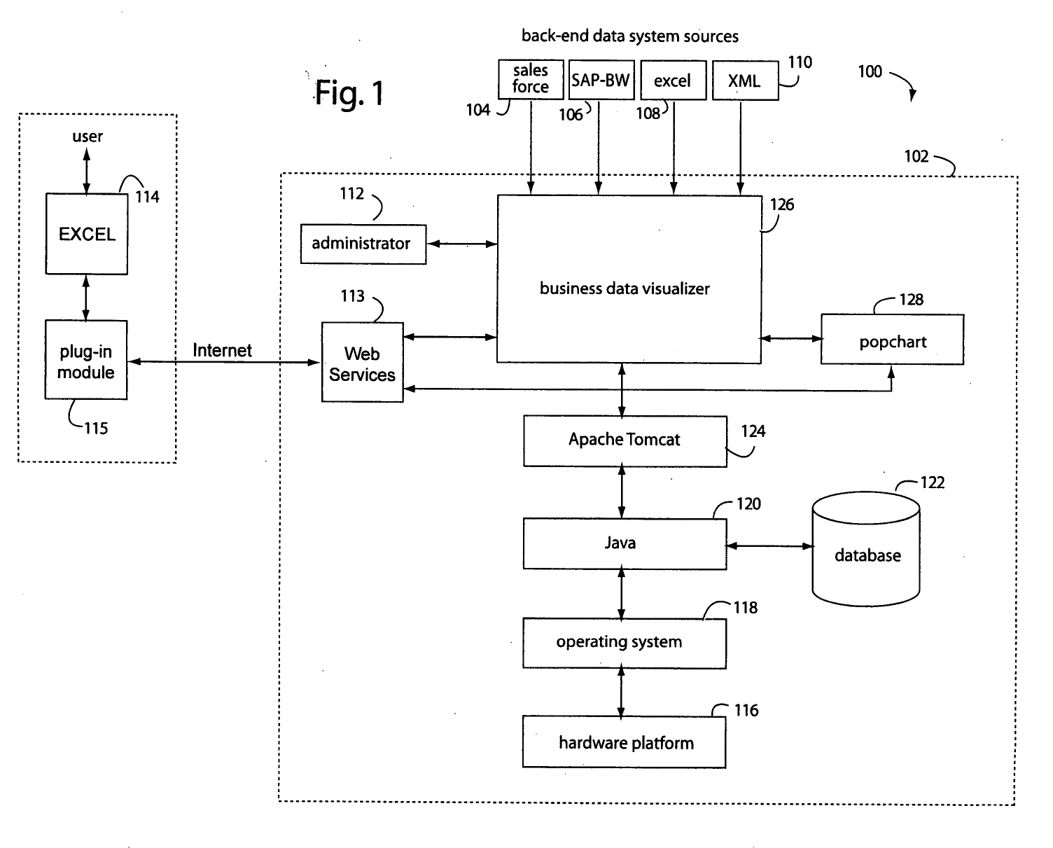

FIG. 1 represents a business data visualization and publishing system embodiment of the present invention, and is referred to herein by the general reference numeral 100. The system 100 comprises a network server 102 that receives field data from several back-end data system sources related to a particular enterprise. For example, the back-end data system sources can include SALESFORCE™ 104, SAP BW™ 106, Microsoft Excel 108, and XML 110 formatted data. A system administrator 112 controls all aspects of how information from data received from the back-end data system sources is extracted, stored, manipulated, correlated, and displayed at a number of Internet-connected clients. Such users log-in and receive standardized and predefined displays of data that help them do their jobs by giving them insights into the performance of the enterprise.

A web services application program interface (API) 113 connects to the Internet and allows a plurality of subscribing users to better visualize data, publish it to the Web, and share it amongst other users. One such user in the field comprises an EXCEL or other spreadsheet application 114 extended by a plug-in module 115. The user interacts with the familiar spreadsheet graphical user interface (GUI) and is provided with a specialized toolbar to control the extended capabilities. The plug-in module 115 comprises an export function to synchronize-exports and to create charts, and an import function to synchronize chart imports from the network server 102. In order to be a commercially viable product, the plug-in module 115 is internationalized and easily localizable. It further includes the ability to be downloaded, installed, upgraded, and uninstalled.

The data visualization and publishing system 100 provides a streamlined and intuitive interface for users with ordinary browsers to rapidly access data sources, visualize information, and publish results. Such enables an enterprise to improve strategic decisions and collaborate more effectively. An intuitive user browser interface at each user is used to cause informational data to be extracted from business applications, databases, and other sources. Data is transformed, merged, and formatted, using a menu-driven graphical user interface. Standalone dashboards, portals, web pages, and components to be integrated into groupware or enterprise portals can be published. A configuration process includes a drill-down wizard, page builder, and visual property editor. Graphical components are published on templates with existing web content using a drag-n-drop web page builder. An account management system with access control is included to protect information security.

The server 102 is based on a suitable computer hardware platform 116 that hosts a compatible operating system 118. Such supports a Java-2 Enterprise Edition (J2EE) environment 120 with a database 122 using, e.g., PostgreSQL 7.3. A base platform 124 is used to provide Java services to a pure Java application, e.g., a business data visualizer 126. For example, the base platform 124 can be implemented with Apache Tomcat 4.1. Tomcat is a free, open-source implementation of Java Servlet and JavaServer Pages technologies developed under the Jakarta project at the Apache Software Foundation. Tomcat is available for commercial use under the ASF license from the Apache web site in both binary and source versions. Any commercial web server that supports JavaServer Pages (JSP) and Servlets can be used with Tomcat, e.g. Sun ONE Web Server, IBM WebSphere, BEA Weblogic and others. JavaServer Pages and Java Servlets are the web presentation layer in the Java J2EE Platform.

The spreadsheet user interface includes an EXCEL spreadsheet application program 114 and a plug-in module 115 for export and import of data and charts with the web services API 113, such that a user can prepare data, publish data as charts and tables on web pages and dashboards, use data extractors, import data, and synchronize spreadsheet updates and dashboards.

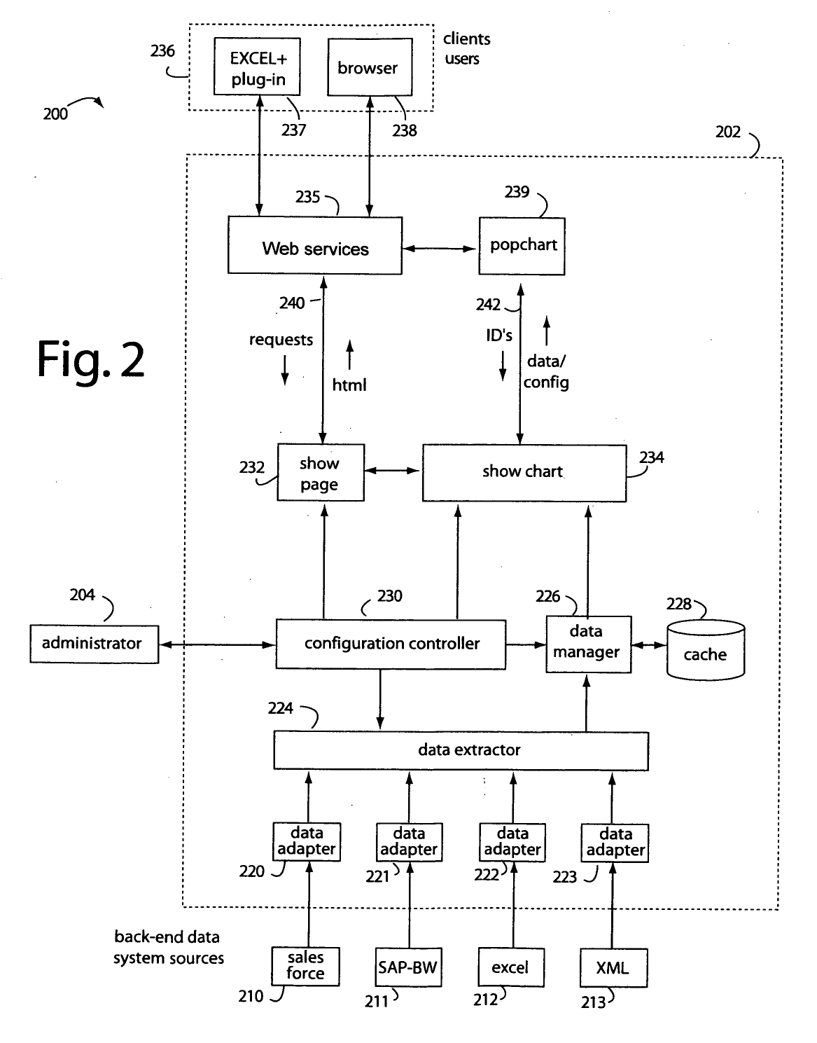

FIG. 2 represents a business data visualizer system embodiment of the present invention, and is referred to herein by the general reference numeral 200. The system 200 comprises a server 202 that is controlled by a systems administrator 204. Diverse business data sources 210-213 provide independent data in a variety of formats, e.g., SALESFORCE, SAP-BW, Excel, XML, etc. An array of data adapters 220-223 convert this data into a standardized format. The administrator 204 defines what is important for a data extractor 224 to gather together and a data manager 226 stores such in a cache 228. A configuration controller 230 fixes the data collection, manipulation, and display activities of the data extractor 224, data manager 226, a show-page HTML generator 232, and a show-chart application 234.

The EXCEL plug-in module 237 includes a publishing wizard to select EXCEL data and publish it through system 202, an extractor interface to select data objects from system 202 and import them to EXCEL, and a synchronizer to update system 202 when the EXCEL data changes. The extractor interface allows access to SAP BW, SalesForce.com, and other sources as shown in FIG. 2

A web services API 235 provides an Internet presence for a number of Internet-based client users 236. Such users have an EXCEL spreadsheet application and plug-in 237 and a browser 238. The EXCEL spreadsheet application and plug-in 237 access system 202 in the background and a typical user will not usually be aware the extended chart support and publishing capabilities are being provided by it. A typical application would, however, require a user to have a paid subscription to benefit from these services. EXCEL data can thereafter be published to B3 dashboards.

Commercial chart application programs can be used to implement a pop-chart application 239, for example, Corda Technologies, Inc. (Lindon, Utah) POPCHART®. POPCHART is described by Corda as a server-based suite of tools for creating sophisticated interactive charts and graphs in Macromedia® FLASH, SVG, PNG, JPEG, PDF, EPS, TIFF, WBMP, etc. A variety of graph images can be fed with on-demand dynamic data. Text boxes, callout notes, and popup text that can appears in graphs or charts is included. POPCHART also has drill-down capabilities and linking to other graphs or charts.

In operation, a client connection 240 is used to receive requests for business intelligence. In response, an HTML message is sent that builds a webpage in the users browser. The show-page generator 232 forwards the requests from the clients to the show-chart 234. Such causes the data to be fetched by the data manager 226 and sent to POPCHART 239. In response, POPCHART 239 uses connection 242 to return the pointer ID's to the generated charts that is supplied back in the HTML messages. The URL addresses are then available for the user browser to link with the chart graphics on the Internet.

Business data is extracted from business applications, databases, and other sources. Data is transformed, merged, and formatted, using a menu-driven interface. The system 200 can publish standalone dashboards, portals, or web pages, as well as components to be integrated into groupware or enterprise portals. The system 200 provide convenient configuration processes through its drill-down wizard, page builder, and visual property editors. Using the drag-n-drop web page builder, graphical components can be easily published on templates or existing web content. The system 200 also provides an account management system with access control to protect information security.

Business data is gathered from many backend systems, system 200 provides strategic advantages to the extended enterprise. The system 200 can be used as a portal, a business console, a dashboard, and a custom reporting solution, to enable an enterprise to quickly visualize its information assets.

The B3 system 200 includes transparent templates for dashboard and instant publishing. Transparent Templates for Dashboard allow users to apply HTML, upload it, and easily apply it as a custom dashboard. Most other products require manual editing of HTML templates. With Instant Publishing that uses the WebDAV technology, The B3 system 200 allows dashboard template uploads, which are instantly applied for rapid development and easy maintenance.

The B3 system 200 web-based embodiments of the present invention are useful in creating and publishing business dashboards. It is a server-side JAVA solution, based on the Servlet 2.3 Specification. A useful platform for the B3 system 200 is the Tomcat 4.1 Application Server and the PostgreSQL 7 database. To generate attractive charts and map graphics, The B3 system 200 can use the POPCHART and Optimap products sold by Corda. The B3 system 200 is based on a Smart Engine framework, a content management system (CMS) toolkit, also developed by Macnica.

The B3 system 200 incorporates a number of tools, including Apache POI for extracting data from Microsoft Excel files, Apache ANT for the primary build tool, Apache Log4j for application logging, Quartz for task scheduling, and XMLC by www.Enhydra.org. According to Enhydra.org, XMLC is the presentation technology that provides a strict separation of markup and logic in a true object view of dynamic presentations. Such presentation technology compiles HTML pages into document object model (DOM) classes and manipulated by Java Servlets. A document object model is an API for HTML and XML documents that provides a structural representation of the document. It defines the way that a structure can be accessed by programming languages, and allows a web page to be accessed as a structured group of nodes. It links web pages to scripts or programming languages.

The B3 system 200 embodiments of the present invention are based on XMLC, an open-source tool which provide an alternative approach to JSP's. With XMLC, HTML templates are compiled into DOM classes, which can then be manipulated by the Java Servlets using standard API's. Such technology provides a complete separation between HTML resources and Java code. There are numerous advantages, one of the most significant is improved localization in terms of initial effort and subsequent maintenance.

The B3 system 200 uses the Smart Engine API which wraps the DOM API, and provides a higher-level interface to manipulate HTML templates. When an HTML template is used to render a dynamic web page, its key elements are identified using an ID-attribute. Such ID-attribute provides a logical name, which may be referenced by the controlling Servlet. Once a Servlet references an identified element, it may be manipulated by rendering text and copying it to form a dynamic structure. Common patterns reference a span or anchor element, and render text to it. Otherwise, they reference a table row element, copy it several times to form a table with a dynamic number of rows. Or such can reference an anchor element, rendering the href and optionally text to provide dynamic navigation and links

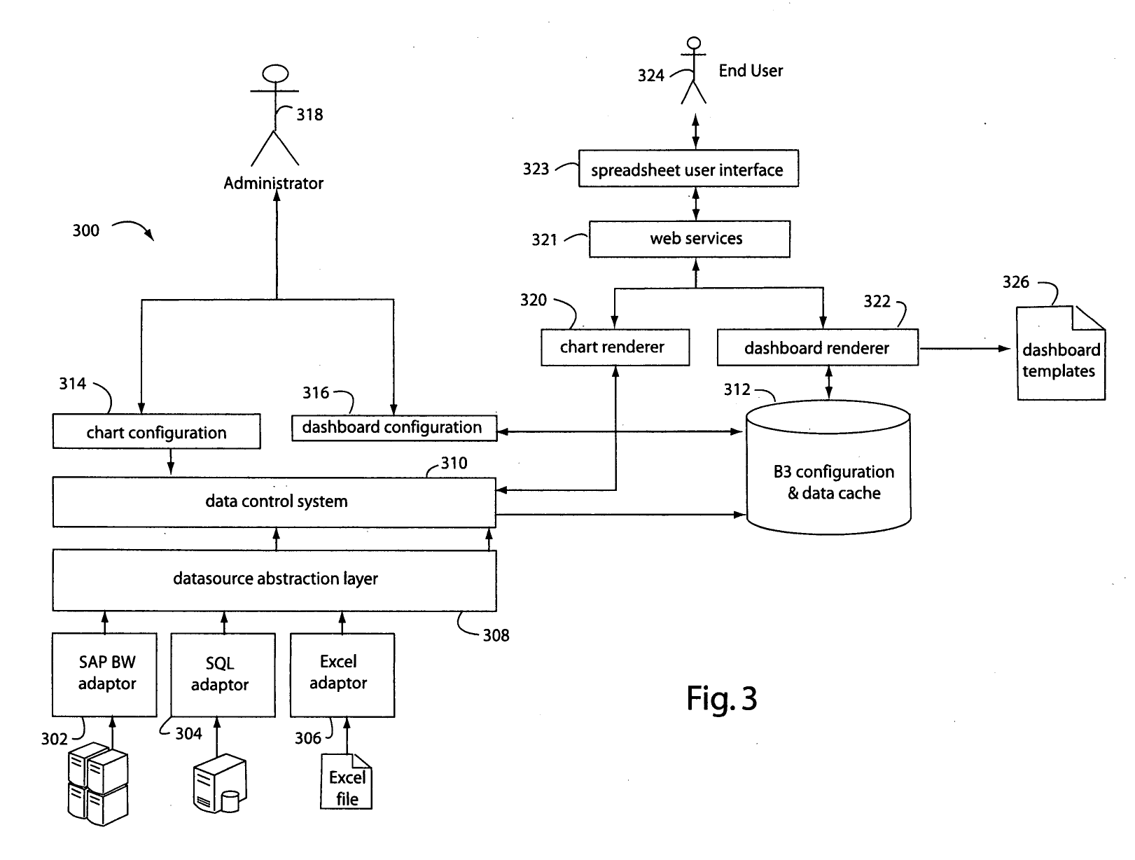

FIG. 3 represents a business intelligence system embodiment of the present invention, and is referred to herein by the general reference numeral 300. Such is similar to system 200 (FIG. 2) and represents a different way to configure the components described herein. The business intelligence system 300 comprises an array of data input adapters with corresponding field data input sources that are represented in FIG. 3 as an SAP BW adaptor 302, an SQL adaptor 304, and an Excel adaptor 306. These all feed a data source abstraction layer 308 that normalizes and unifies the data. A data control system moves data according to administrator settings to a B3 configuration and data cache 312. A chart configuration process 314 and dashboard configuration process 316 are directly controllable by only an administrator 318. A chart renderer 320 receives the configured chart data and creates a graphic in a webpage. A web services API 321 interacts over the Web with a plurality of users. A dashboard renderer 322 may send dashboards in a webpage chosen by the administrator to an end user 324 along with rendered charts for EXCEL use through a plug-in 323. A series of dashboard templates are used by the dashboard renderer 322.

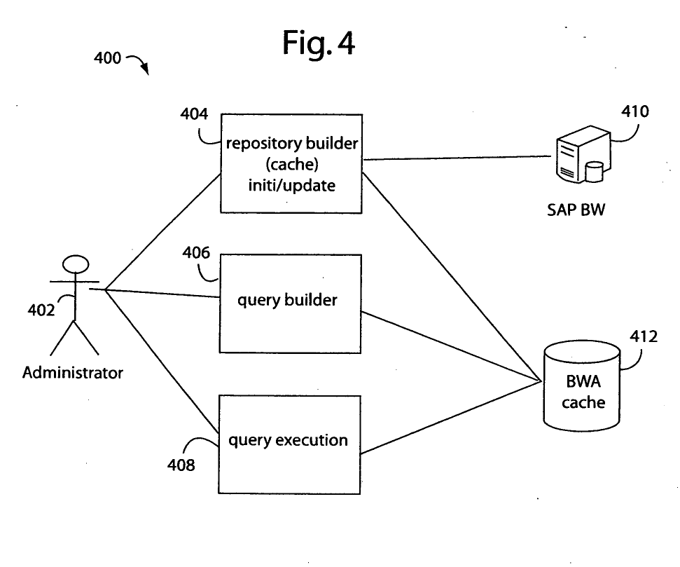

FIG. 4 illustrates a BW access adapter 400, useful in the systems illustrated in FIGS. 2 and 3. The BW access adapter 400 is controlled by a systems administrator 402 who preconfigures a repository builder 404, a query builder 406, and a query execution processor 408. The repository builder stores BW metadata into the BWA cache 412. These components form a custom BW Adapter (BWA) to access the SAP BW system 410 in the field.

The B3 system 200 typically includes data extraction, publishing, and resource management. The system can be roughly divided into (1) data extraction, (2) page creation, and (3) publishing. A B3 system 200 prototype included three major components (1) Corda POPCHART included an OEM version of the product, (2) CMS Smart Engine included the CMS data and presentation framework, and (3) the B3 system 200 application embodiment of the present invention. An additional folder, DEPLOY, was includes the Tomcat application server and other deployment related items. The B3 system 200 folder included the files in the following Table.

| File Name | Function |
|---|---|
| b3/build.conf | provides the compile-time config- |
| | uration for The B3 system 200 |
| b3/build.properties | provides run-time configuration for |
| | The B3 system 200 |
| b3/setup.sh | sets up symbolic links on UNIX, |
| | which are essential for the HTML |
| | resources to build properly |
| b3/build.sh | a script used to compile the entire |
| | application |
| b3/build.xml | the ANT build file |
| b3/database | contains various database scripts |
| | as SH and SQL |
| b3/input | source files, which are processed |
| | during build, many of which are |
| | output into b3/output |
| b3/input/webapps | Tomcat webapps directory, which |
| | includes Corda “pcom” and The B3 |
| | system 200 “bizcubed” |
| b3/input/xe | XE resouces |
| b3/input/xe/lib/[locale] | XE transform files, organized by |
| | locale |
| b3/input/xe/XE.xsd | XML schema for XE transform files |
| b3/input/xe/xe-checker.sh | script to check XE transform files |
| b3/input/deploy | deployment scripts, used for The B3 |
| | system 200 installation |
| b3/input/conf/server.xml | Tomcat 4 configuration file |
| b3/input/conf/optionsHTML.xmlc | XMLC configuration file |
| b3/input/conf/log4j.conf | Log4j configuration file |
| b3/input/conf/quartz.conf | Quartz configuration file |

The B3 system 200 can integrate modular and packaged applications and services to manage its data. A Smart Engine is used for chart properties, page configuration, and other configuration data. Additionally, The B3 system 200 includes its own data management system for chart data. There are also other components to support specific data types: system schedules are managed by Quartz, and SAP BW metadata is managed by a custom component called BWA.

The B3 system 200 uses Smart Engine content-management framework for data access. Most of the configuration properties are stored as content data. The Smart Engine provides a tree-like structure for organizing and storing content data.

Smart Engine includes various classes for CMS access, e.g., (1) jp.co.macnica.cms.biz.ContentSet, which represents a set of properties in the CMS; internally, this is represented as a node in a tree, and leaf items off of that node, (2) jp.co.macnica.cms.biz.ContentItem, which represents an item in a ContentSet and is used to load/store each data element. Internally, this was represented as a leaf node in a tree, and (3) jp.co.macnica.cms.biz.ContentManager which was a main interface for loading and saving content sets.

Smart engine content publishing in the B3 system 200 provides a high-level template system which wraps the functionality of XMLC and DOM. The B3 system 200 provides both simple direct tools and a sophisticated framework, both are used depending on context. The key classes in the direct system were (1) XmlTemplate which wraps an HTML page or an area of the page subtree of the DOM, (2) XmlCopier which is tool to copy XmlTemplates, providing dynamic structural manipulation, and (3) DomUtils which is set of static classes to render text, form fields, and other common operations.

The B3 system 200 provides a solution for managing data sources. It includes a three-step wizard for extraction, where a data set is defined, configured, and reviewed (and optionally edited). During the define process, the admin provides a name for the data set and selects the data source. The list of data sources is dynamic, automatically generated from the available data extractor components. After selecting a data source, the admin moves on to the Configure step, which is provided through the data extractor plug-in. After completing configuration and extracting data, the plug-in component redirects the user to the third step, where the data can be reviewed and optionally edited.

Data extractor API's are used in the B3 system 200 to support a variety of data sources, e.g., Microsoft Excel, CSV, XML, SQL, Salesforce.com SForce, SAP BW. The B3 system 200 can be expanded to support additional sources through the development of new extractor components. An extractor component must provide (1) a Web user interface class and (2) a Data Source Builder class. The Web user interface class extends jp.co.macnica.bizcubed.web.admin.ChartConfigBase, and provides an event named “displayItemDetails”, and at least one other event for saving configuration. Such can be named and vary according to the component). These functions are provides through a single method, “handleEvent( )”, which may delegate as needed. After completing the configuration, the Servlet should redirect the user using the method “redirectToEditor( )”.

The Data Source Builder class extends jp.co.macnica.bizcubed.web.admin.builder.BuilderBase to provide the items in the following Table.

| | |
|---|---|
| getName( ) | get logical name for the data sources |
| getLabel( ) | get a locale-specific label for the data |
| | source. Such is used to generate the |
| | description in the HTML page for Chart |
| | Builder Define. |
| showInMainMenu( ) | returns a Boolean indicating whether this |
| | component label should appear in the main |
| | menu. Normal components appear in the |
| | Extractor menu only, so this should be set |
| | to false. |
| showInExtractorMenu( ) | returns a Boolean indicating whether this |
| | component label should appear in the |
| | extractor menu. Normal components appear |
| | here, so this should be set to true. |
| buildDataModel( ) | this provided the main function of |
| | extracting data from a source system, and |
| | returns a DataModel, representing a tabular |
| | data set. |
| getServletUrl( ) | returns the URL for the Servlet which |
| | handles this function. Such URL should |
| | point to the Web user interface class, |
| | defined in part 1 above. |

XE is a subsystem in The B3 system 200 that allows for complex transformations. Transforms are defined on local The B3 system 200 data, which has been previous extracted from external data sources. Once source data is available, it may be transformed, converted, reduced, or otherwise manipulated to a convenient form for presentation. XE prepares data for presentation, and is not an analysis tool. XE processes any number of XML definition files, e.g.,

<xe>

<transform name=“x” type=“y”>

<label>Sample Transform</label>
<description>Your average xform</description>
<parameter/>
...
<parameter name=“date-criteria” type=“date-criteria”>
<sql/>

</transform>
...

</xe>

The transform labels are loaded into the B3 system 200 user interface (UI), making the transform available to the user. Such The B3 system 200 user interface interprets the parameter metadata and generate an appropriate configuration user interface. After the user interacts with the user interface, they save their transform configuration, and XE will compile transformative SQL based on the user configuration and the SQL template in the XE control file. Subsequent execution of the SQL produces a data transformation.

The graphic user interface (GUI) presents a list of all transforms, and also a “Custom” option. The Custom option will allow direct entry of SQL. If a transform is created from a predefined formula, it can be converted to “Custom” by a user clicking on a button, “Customize”.

XE Transform Types

| TYPE | Description |
|---|---|
| CATEGORIES | provides category data (column name is “category”) |
| SERIES | provides series data (column name is “value”) |
| DATE- | provides SQL expression that evaluated to a date |
| EXPRESSION | |
| CATEGORY- | provides SQL conditional expression (for a WHERE |
| CRITERIA | clause) to select subset of categories. Expressions |
| | can contain reference to field “category”. |
| SOURCE- | provides SQL expression of data source (for a FROM |
| EXPRESSION | clause). |

All XE Parameters support name and label. The name is a unique logical identifier, used internally. The label is displayed when the field is generated in the wizard user interface.

| TYPE | STRING | |
|---|---|---|
| Description | free form text | |
| Attributes | Name | Description |
| | validate | regular expression |
| | default | default value |

| | |
|---|---|
| Example | <parameter name“decimals” type=“string” default=“2”> |
| | <validate>\d*</validate> |
| | <label>Select the number of decimal digits</label> |
| | </parameter> |

.
.
.

| TYPE | DATE | |
|---|---|---|
| Description | date input, with variable precision | |
| Attributes | Name | Type |
| | precision | precision of date selection (day, month, year) |
| Example | <parameter name=“year” type=“date”> | |
| | <precision>month</precision> | |
| | <label>Date</label> | |
| | </parameter> | |
| Uses | date ‘2002-03-01’ | |
| | NOW( ) - interval ‘1 month’ | |
| TYPE | DATE-FORMAT | |
| Description | free form text with date macros | |
| Attributes | Name | Description |
| | default | value |
| Example | <parameter name=“df” type=“date-format” | |
| | default=“YYYY-MM”> | |
| | <label>Select a data format</label> | |
| | </parameter> | |
| TYPE | MODEL | |
| Description | DataModel | |
| Attributes | Name | Description |
| | Example | <parameter name=“model” type=“model”> |
| | | <label>Select a model</label> |
| | | </parameter> |
| | | produces ${model} |
| TYPE | MODEL:SERIES | |
| Description | Series in a DataModel | |
| Attributes | Name | Description |
| | Example | <parameter name=“model” |
| | | type=“model:series”> |
| | | <label>Select a series from a model</label> |
| | | </parameter> |
| | | produces ${model} and ${model.series} |
| TYPE | XE:TYPE | |
| Description | another transform, with type indicated | |
| Attributes | Name | Description |
| | Example | <parameter name=“query” type=“transform”> |
| | | <label>Select a series from a model</label> |
| | | </parameter> |

A Series Transform (xe:series) is a primary transform for producing series data. The results are formed from rows of query results, with the relevant values contained in the first column and named “value”. Additional columns may be present, but are query specific and are processing byproducts. For example, a second column may contain temporary ordering values.

A Categories Transform (xe:categories) is a primary transform for producing category data. The results are formed from rows of query results, with the relevant values contained in the first column and named “category”. Additional columns may be present, but are query specific and are processing byproducts. For example, a second column may contain temporary ordering values.

A Source Expression Transform (xe:source-expression) is a secondary transform for producing source expressions.

A Category Criteria Transform (xe:category-criteria) is a secondary transform, allowing most queries to be extended with additional criteria. These expressions operate on category data, but can be applied to Series and Category Transforms. When a Category Criteria Transform is used, an additional wizard should be enabled, allowing a choice between all transforms of type=“xe:category-criteria”. The results of this secondary wizard are in-lined as directed by the parameter of the primary transform. If the category criteria is not selected, XE will generate “TRUE” to satisfy the constraint.

A Date Expression Transform (xe:date-expression) is a secondary transform, allowing most queries to be extended with common date expressions. These expressions are self sufficient, and when evaluated they produce a single Date value. They can be applied to Series and Category Transforms. When Date Expression Transform is used, an additional wizard should be enabled, allowing a choice between all transforms of type=“xe:date-expression”. The results of this secondary wizard will be in-lined as directed by the parameter of the primary transform. A date-expression must be completed if indicated the parameter definition of the primary transform.

Parameters are used by directly substituting results from external sources. The parameter type attribute indicates the source, and can be a simple source like direct text input, or complex source like selected series in a model, or chained source like query or query expression resulting from another XE transform.

XE supports various simple parameters, which can be defined using simple text entry widgets, and supported by efficiency widgets. Common types include text strings, dates, date formats. Strings can be constrained using Regular Expressions. Dates can be constrained by precision (month, day, year). Dates can be entered literally or through a Calendar Widget. Date-formats are evaluated for rendering dates. They may contain arbitrary text, and date elements indicated by the following Table.

| Pattern | Description |
|---|---|
| YYYY | year (4 digits) |
| YY | year (2 digits) |
| MM | month |
| DD | day |
| Q | quarter |

The to_date( ) and to_char( ) functions of PostgreSQL 7.3.3, are used provide more extensive formatting and parsing. Chained Sources are results from other transforms. Transforms can often be combined, allowing results of one to serve as input for another.

At Top level, the CMS included web—Servlet and presentation framework; data—CMS database interface; biz—CMS interface for users and content data; and common—basic utilities for any application.

A CMS Common: Utilities package include utilities that are used throughout CMS and The B3 system 200. Key classes include CmsException—base exception which PathNotFoundException extends; CmsSystemException—base Runtime exception which application exceptions should extend; StdUtils—assortment of static utility methods that parse, format, and operate on basic variables; and ContentPath—represents a path in the CMS.

A CMS Common: Errors package provides access to locale-specific errors. Error key constants are associated with properties in resource bundles. These classes are used to look up the locale-specific errors.

A CMS Common: Logging package provides a wrapper around the application server logging system. The only logger implementation is for Apache Log4j, however other loggers could be used instead. The Log class is the main service for generating log messages.

A CMS Data package and subpackages are not normally accessed directly. The BaseDO and BaseDAO provide superclasses for user, language, and content data types, which are available as subpackages. If a DAO operation is unsuccessful in resolving a named reference, a NotFoundException is thrown.

A CMS Data: Content package provides all low-level services for CMS data persistence. The primary engine ContentDAO is backed by a cache, e.g., CachedContentDAO which decorates as a subclass. The true caching is done by a delegate class, Cache. The main data object is ContentDO.

The CMS manages data using a tree-like structure, composed of content Nodes with content Values. A unified tree provides for the structure of all content data. Applications can organize the tree as they see fit. Most common data structures can be emulated by the tree structure, including lists of data. All content data is actually stored as SQL TEXT values in the database, unless the Content is handled as a file, in which case it will be stored as a file by the CMS. Each content Node will be assigned a unique ID, which can be later used for tracking. CMS biz.content provides a convenient and high-level interface for managing CMS data.

A CMS Data: File Storage package provides low-level services for managing file resources. Instead of serializing large data objects to the database, files are represented as raw data in the CMS. The file storage system utilizes a custom storage technique to organize and name files, guaranteeing that files uploaded with duplicate names do not conflict. As with the base CMS data, this package should not be used directly. The business-level content system should be used instead.

A CMS Data: User and Language are special packages for managing user and language resources. While the CMS could be organized to provide a user service, a system-level user system is needed for content management. The Language class represents languages that the CMS supports. By default, English and Japanese are defined, but other languages could be easily added. In addition, the User class provides for user representation, so content can be associated with user at the system level.

A CMS Business layer is divided into three areas (1) content—provides the core CMS services; (2) media—provides services for storing files directly; and (3) user—provides user and locale related services.

A CMS Business: Content management services uses a simple API, composed of the following classes:

| | |
|---|---|
| ContentManager | provides services to load and store ContentSets |
| ContentSet | represents a set of data, such as a flat set of |
| | properties. ContentSets may also contain other |
| | ContentSets, forming a hierarchy |
| ContentItem | represents an actual piece of content data, which |
| | may be available as a textual value or an external |
| | media file |
| ContentFilter | filter which operates on a ContentSet.toList( ) to |
| | sort, search, or otherwise modify content items. |

The standard CMS interfaces are implemented by an SQL adapter. Other adapters have been developed in the past to support SOAP, JavaBeans, and others, but are not being actively maintained.

For CMS Business: Media, CMS provides an integrated media storage and management system. A media resource may be attached to a ContentSet, and managed through this system. The MediaManager class is used for these purposes.

For CMS Business: Users, CMS provide a system for managing Users and Languages, which will qualify CMS data. The User and Language concept can be associated with any CMS content data. These classes should be used to find users, validate their passwords, and standard persistence operations (CRUD). Please note that applications may need to maintain their own user account database, in order to store additional data about users. Applications can also use the CMS User system minimally, creating a standard account only, and providing user services at a higher level. Such will prevent CMS associations between users and content, but it will provide custom functionality and more flexibility, if needed.

The CMS provides a presentation framework for mapping CMS data to web pages. The web framework also includes advanced utilities for rendering fields, field validation, page events, and Servlet services. The main tools are located in the common package. There are also some utilities available in the util package, which provides for CMS debugging as well as backup and recovery.

CMS contains an advanced, flexible framework for creating content-managing applications. The package includes subpackages for:

| | |
|---|---|
| templates | CMS utilizes a flexible tool called XMLC, which |
| | represents HTML templates using DOM. Using DOM |
| | the HTML template can be manipulated to produce |
| | the output page. CMS provides a convenient |
| | framework around DOM. |
| mail | CMS has functionality for sending email to |
| | users. |
| Framework | the CMS framework provide dozens of tools for |
| | supporting all aspects of web development. |
| | These tools rely on the web template framework. |

The main package includes several critical classes:

| | |
|---|---|
| WebServlet | wrapper around the javax.servlet.HttpServlet, |
| | providing services to utilizes the XMLC template |
| | framework, and numerous convenience utilities. |
| WebRequest | wrapper around javax.servlet.HttpServletRequest, |
| | providing additional services, such as |
| | transparent access to standard HTTP parameters |
| | and files uploaded via HTTP |
| WebResponse | wrapper around javax.servlet.HttpServletResponse, |
| | providing additional services, such as proper |
| | configuration of locale. |
| CmsSessionData | extension to the standard Servlet SessionData, |
| | which provides for mapping an autogenerated key |
| | to properties. The autogenerated key can be |
| | created and passed through the HTTP request, |
| | providing a simple solution for supporting |
| | multiple browser sessions per user. (In most web |
| | browsers, a user can create multiple HTTP |
| | sessions, which have state due to a cookie. |
| | However, the cookie is often shared between |
| | multiple sessions for a single user, allowing |
| | potential state conflicts. Such can only be |
| | avoided by passing along a more granular |
| | cookie/key as an HTTP request parameter.) |
| CmsServlet | extends WebServlet, binding its functionality to |
| | the CMS. Such provides convenient access to the |
| | CMS and its services. Application-level Servlets |
| | should normally extend this class. |
| CmsServletAdapter | this class provides standard implementation for |
| | many of the abstract methods defined in |
| | CmsServlet. For convenience, it may also be |
| | extended by application Servlets. |
| UrlBuilder | this class is used to compose a URL, providing |
| | JAVA methods to add parameters and properly |
| | encode the URL. All URL's, such as those created |
| | for Servlet redirection, should be created by |
| | this class. |
| DomUtils | this class contains static methods, which can be |
| | used for manipulating the HTML resource page. |
| | These methods can be used to directly manipulate |
| | the DOM, or the high-level framework can be used |
| | for these purposes. |

CMS provides a convenient framework for working with HTML templates which are compiled into DOM by XMLC. The main classes are:

| | |
|---|---|
| TemplateManager | provides services to load locale-specific templates |
| XmlTemplate | provides a wrapper around an org.w3c.Document, the |
| | main interface representing an HTML DOM |
| XmlPage | extends XmlTemplate to provide page-specific services |
| XmlCopier | created by an XmlTemplate to copy a portion of it. |

Dynamically generated lists, tables, and other repeated elements may be generated using this tool.

XmlTemplate and XmlCopier bind to portions of HTML template using an HTML tag ID. Such ID is the id attribute found on HTML tags, e.g.,

<ol>

<li id=“item”>List Item #1</li>

</ol>

If a list is dynamically generated, a copier can be created with its “item” element, and copied for each desired element in the list. The Copier and related classes take care of the DOM mechanics, and automatically cleanup the original template item.

The CMS framework provides a sophisticated collection of object-oriented tools to render fields, handle events, validate input, and generate dynamic widgets. The key classes are:

| | |
|---|---|
| CmsRenderer | main interface to indicate a class has |
| | rendering capability, using CMS data |
| CmsWriter | main interface to indicate a class can handle |
| | form variable input, which will be written to |
| | the CMS |
| TextRenderer | simple Renderer to render some text |
| BasicCmsRenderer | abstract class that render data from the |
| | CMSRenderer |
| AnchorRenderer | renders the HREF of an A element |
| ItemSelector | render sets of values for use in a SELECT list |
| CmsWorker | implements CmsRenderer and CmsWriter, |
| | indicating full-cycle support |
| ItemTextRenderer | renders text from the CMS |
| RemovalRenderer | when rendered, a template area will be removed |
| ItemFieldRenderer | main class to render CMS data to form fields |
| TableBuilder/ | classes to generate dynamic data from the CMS |
| RowBuilder | |
| Validator | interface that identifies a class that provide |
| | validation service |
| FieldValidator | interface that identifies a class that provide |
| | validation on a simple field |
| ValidationException | thrown when Validation fails |
| CmsComponent | interface to indicate a component that |
| | validates |
| CmsWorkerGroup | a grouping component, that allows any set of |
| | components to be added as children, providing |
| | for grouping and hierarchy. Other |
| | CmsWorkerGroups may also be added. |
| CmsField | like ItemFieldRenderer, but handles CmsWriter |
| | services as well |
| ListBuilder | sophisticated component that provides list |
| | generation, with anchor indexing |

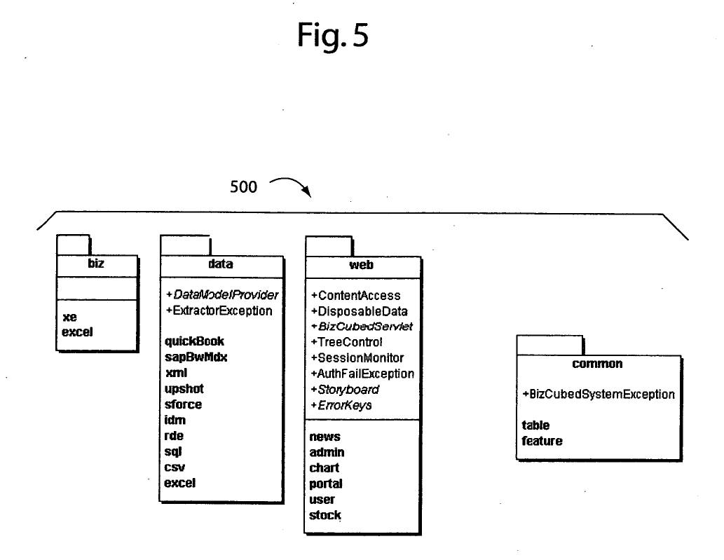

Referring now to FIG. 5, the B3 prototype system was organized similarly to CMS, with three tiers of organization, representing data, business, and web. A fourth package provides common services.

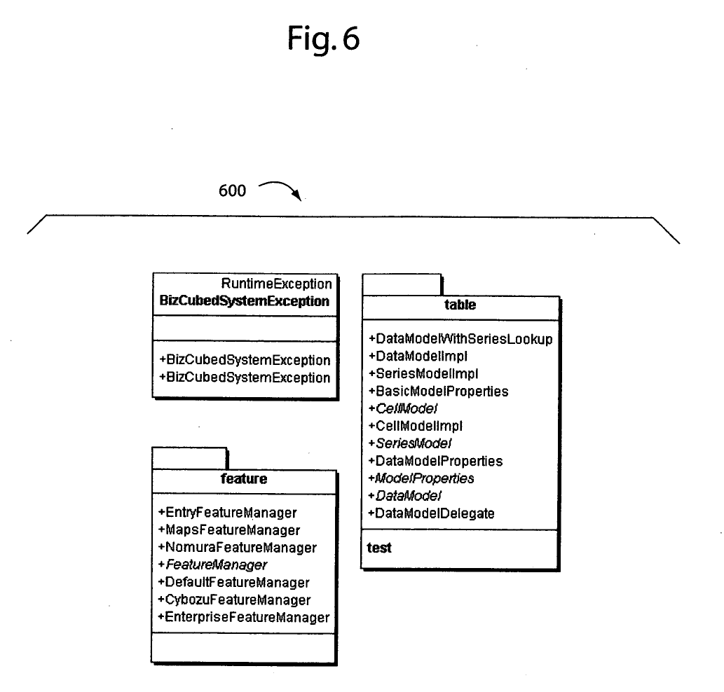

As illustrated in FIG. 6, the B3 system 200 included several common classes to aid other layers of the application. A BizCubedSystemException class provides a standard RuntimeException that classes can throw when they encounter a non-recoverable error. There are also two key subpackages: (1) table, which provides a base interface for representing raw data for tables/charts; and, (2) feature, which is feature-management system that allows components of The B3 system 200 to be enabled/disabled based on the user's license key.

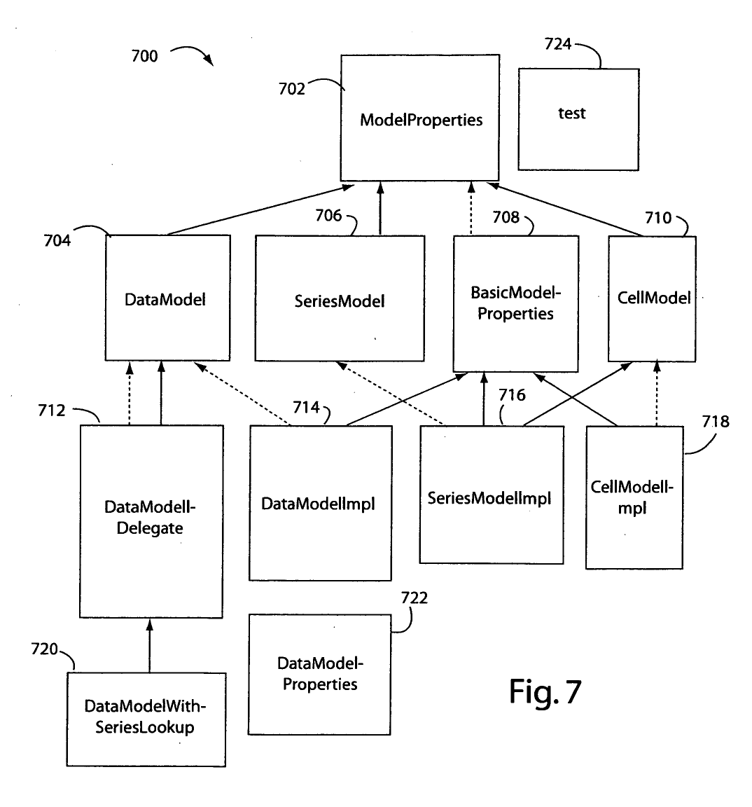

Referring now to FIG. 7, A B3 system 200 Common: Table 700 includes classes that are used for the internal representation of data in The B3 system 200. Such includes a ModelProperties 702, a DataModel 704, a SeriesModel 706, a BasicModelProperties 708, a CellModel 710, a DataModelDelegate 712, a DataModelmpl 714, a SeriesModelmpl 716, a CellModellmpl 718, a DataModelWithSeriesLookup 720, a DataModelProperties 722, and a test class 724. The DataModel 704 is the main representation of tabular data. Such DataModel represents a tabular data set with various properties. The DataModel stores the rows as a list of SeriesModels and the column headers as a list of CellModels. SeriesModel 706 represents a series of data in the table and the series header. The CellModel 710 represents a cell of data, including a single value, and perhaps property attributes. The ModelProperties 708 represents a set of properties, which may be associated with the other classes above. DataModelProperties 722 is a set of constants that refer to properties in ModelProperties. The DataModelWithSeriesLookup 720 decorates DataModelImpl to provide more efficient lookup of SeriesModels.

A FeatureManager provides a set of properties in its interface that components use to determine if a feature is available for deployment. Various builds of The B3 system 200 include special configuration, which activates one of the FeatureManager subclasses to control feature set.

A B3 system 200 data layer provides the code to access low-level or external data. Such package provides data source adapters, which support extraction of data from external systems or non-native formats. The package also contains “idm”, which is used to cache the data extracted by the adapters.

A B3 system 200 Data: Internal Data Model package provides for persistence of internal DataModels. When data source adapters extract data, they represent this data using a common interface called DataModel. DataModels are stored on the B3 system 200 server so they can be quickly accessed at a future date. Such package also provides the persistence for XE. The keys classes were as follows,

| | |
|---|---|
| DataModelDAO | provides for persistence of the DataModel |
| XeDataExtractor | accesses DataModels local cache to support |
| | requests by XE |
| IdmFormula | represents an XE formula for extracting data |

A B3 system 200 business layer primarily contains the XE engine.

A B3 system 200 web layer provides the core of The B3 system 200, e.g.,

| | |
|---|---|
| admin | provides all of the admin pages and services |
| portal | provides the user services to publish the charts |
| | and portal pages |
| chart | interface to Corda POPCHART, which render charts |
| | and maps for the system |
| user | provides user login and password related services |
| The following | |
| classes are key: | |
| BizCubedServlet | provides common The B3 system 200 services, which |
| | all Servlet extend |
| ContentAccess | convenience class for accessing common The B3 |
| | system 200 data structures |
| ErrorKeys | set of constants which are used to identify error |
| | messages in Resource Bundles. |

A B3 system 200 Web: Users package provides Login and Logout Servlets for user access control.

A B3 system 200 Web: Portal package provides classes to publish web pages to end-users. The keys classes are:

| | |
|---|---|
| Portal | renders portal page |
| DataExport | exports data as CSV output |
| TabelView | render popup table to show data in a chart |
| LargeChart | renders popup view of an enlarged chart |
| ChartHelp | renders optional help message associated |
| | with any char |
| Publisher | extends Catalina WebDAV Servlet to publish |
| | The B3 system 200 portal resources for |
| | external maintenance |
| ShowChart | renders a Chart |
| ShowGroupChart | renders a ChartGroup |

A B3 system 200 Web: Chart package provides the interface to Corda POPCHART. These classes send the raw data and custom configuration to POPCHART, controlling the data and appearance of charts.

A B3 system 200 Web: Admin package contains all administrative Servlets and many related tools.

A B3 system 200 Web: Admin Builder provides a flexible framework for data source adapters. New adapters can be added to the system through simple registration and implementation of the Builder interface. The Builder interface provides methods to control data extraction and adapter management.

A B3 system 200 Web: Admin Jobs This package contains the system scheduler, which can run tasks at user defined intervals. Currently, the only task supported is Regenerate All, a function that extracts all data from the sources, and regenerates all XE charts.

The system provide for interactive data visualization, including drill-downs, chart groups, popup text, and more. Drill-downs are used for navigation through detailed data. Chart groups collect related charts together, providing access to different views through a select list. Pop-ups provide additional information as the user moves their cursor across the chart. The system can also provide a tabular view and an enlarged view of any chart.

The system provides powerful ETL functions, which can be easily configured using an intuitive user interface. The system can extract data from SAP BW, SAP Reports, RDBMS using SQL, Sales Force, Excel, XML, and CSV. In addition, the system provides an interface for third party ETL tools and custom extraction procedures.

The system can publish data as a table or using a wide-variety of charts. The system supports over 27 chart types, and numerous properties can be customized, including fonts, colors, and styles. Charts can be generated as Flash, SVG, JPEG, and PNG.

The system is a pure Java application that runs in a J2EE environment. The base platform is Apache Tomcat 4.1. The system also can use PostgreSQL 7.3.

the system include some or all of the following elements: data extractors to access SAP BW, SAP Reports, RDBMS using SQL, SALESFORCE, Excel, XML, CSV. Interactive features—drill-downs, chart groups, pop-up text, and more. Publishing—create web pages, dashboards, and portals, or publish content to groupware and external portals. Configuration—customize appearance, properties, and functions using menus and wizards. Transformation engine—a powerful system to convert data, format results, merge data sources, and manage together seamlessly. Account management—role-based access control for web pages. System scheduler—automate data extraction. Folder-based manager—organize resources using a tree of folders. Web resources—upload using WebDAV or ZIP files. Integration-interface for third party ETL tools, accounts can be imported from other systems.

The system provide a unique data transformation system to enhance enterprise integration. A Transformation Engine (XE) allows users to easily transform data for analysis and visualization. Transforms can be used to merge data from multiple sources, apply standard and custom formulas, convert data to more convenient forms, and format results. With the aid of dynamic parameters, it can also be used to provide ad-hoc analytical capabilities.

XE Transforms are configured through a high-level user interface, using menu-driven wizards. Many common procedures can be done without any programming or scripting. XE provides over a dozen standard transforms, and the library can be expanded. The user interface is based on high-level concepts of transformation, and doesn't can utilize concepts of relational databases or multi-dimensional analysis (OLAP). Such approach also avoids the complexity of query languages like SQL and MDX as well as programming in VB, C, or Perl. Users can do sophisticated data transformations with minimal knowledge of the underlying processes.

The value of XE extends far beyond a high-level user interface for data transformation. XE is actually a framework for building transforms, driven by an XML library. It utilizes XML configuration files, which define formulas and control the web-based configuration user interface. The library can be customized by vendors, partners, and IT departments to provide additional transforms. The XE XML format is designed to be simple and reusable. Transforms can be broken up into reusable parts, and nested for sophisticated behavior. The XML files can be modified and activated by simply copying them into a registered folder on embodiments of the B3 system 200 XE system. Through this system XE can be expanded and customized as needed.

XE extends embodiments of the B3 system 200 data management system. The transform system is supported as a data extractor, and it uses the results from other data sets. The system provide model transform, which operates on the entire data model, and series transforms, which are defined for each series in the data model. Data model transforms are more powerful and specialized, while series transforms are more dynamic and flexible.

Since XE can include any number of transforms on top of a data source, it includes a sophisticated dependency system. Such system tracks the dependencies between the system data-models, and guarantees that the transformation process is coherent. Data generation follows dependencies from the final results down to the source data, ensuring that extraction occurs first, followed by the proper sequence of formula processing.

Overall, XE is a powerful and convenient solution for transforming data. It provides solutions to common problems, from calculating formulas to combining data from multiple sources. It is expandable and customizable, so it can be adapted to new requirements in the future. XE provides transformation capabilities without low-level programming or multi-dimensional analysis.

The types of transformations that are possible are many. Data from different sources can be used to merge historic data, combine parts into a whole, provide together for comparison; calculate formulas such as sum, ratio, percent differences, moving totals, average values; format results like scale values, round, set precision (decimal digits), convert date formats; limit results such as select by date range, select by dates from other data sets; overall conversion convert of an entire set of data such as swap data in columns and rows, convert a list of data points (vectors) to a tabular format, randomize data to a maximum difference.

The system is a web-based solution for publishing business data. It allows users to easily visualize data using interactive charts, dashboards, and portals. It provides a convenient management system to extract, transform, and publish data, using intuitive wizards and menus. The system provide ETL functionality to extract data from diverse sources, including SAP BW, SAP Reports, SForce (SALESFORCE), SQL, XML, Excel, and plain text files. The product also includes an advanced Transformation Engine, which provides sophisticated data transforms through a menu interface, without relying on programming or scripting. The system utilizes Corda POPCHART to generate rich charts, graphs, and map graphics. Charts are customized using a WYSIWYG interface, and Business Dashboards are constructed through a simple drag-n-drop process. The product also provides an account management system with access control to protect information security. With the system users can begin visualizing data in a matter of minutes, and easily manage reports in the future.

The system is uniquely focused on SAP, providing special tools to use SAP data. The system can access Query Cubes in SAP BW. It can also access standard and custom R/3 reports. Once data has been extracted from SAP, it can be managed by The B3 system 200, transformed and merged with other data sources, and easily published as a dashboard or business portal. The system is a powerful solution for harnessing the information available in SAP.

SAP Business Information Warehouse (BW)

the system supports SAP Business Information Warehouse (BW). The system provides a simple web-based user interface to configure BW as a data-source. The system can access any query cube in a BW system. The user interface allows the user to select a query cube, and configure dimensions, key figures, filters, and variables. Such configuration is used to create a dynamic query. Once executed, results from BW appear as any other data in The B3 system 200.

The system uses a BW Adapter component to access BW systems. Such adapter periodically extracts meta-data from BW to build a local cache. Using the cache, the system provides a responsive user interface and high-performance data access.

The system provides an integrated user interface to configure data selection from BW. Normally, BW administrators define query cubes to provide access to various types of business data. The system can access any data in a BW query cube.

To extract data from BW, the administrator creates a new graph object, selecting a unique name and choosing SAP BW as the data source. The system will then present a BW Configuration user interface. At the top of the page, the administrator selects a query cube to access. They are presented a tree view that can be navigated by descending through BW InfoAreas and InfoCubes. Once a query cube is selected, the administrator can configure the extraction process.

A cube contains data elements (key figures) that are organized by multiple dimensions. Dimensions provide properties (such as time, sales office, product, customer), while key figures usually provide numerical data (facts such as price, margin, inventory values). The administrator selects the dimensions and key figures they want to use. Dimensions and key figures are mapped to rows and columns in a table. By selecting dimensions and key figures, the system is configured to capture a view of the multi-dimensional results. Dimensions and key figures are selected using a popup dialog, which presents these elements as a dynamic tree.

Query cubes may also can use SAP variables to control their behavior. The system user interface presents these variables for the administrator to select from popup value lists. Variables provide dynamic behavior in BW queries.

The administrator may also define filters, which are configurable criteria to limit data results. A list of filters can be defined by the administrator using a popup dialog. The dialog presents a tree of dimensional elements. The user selects values from the hierarchy to limit (filter) results. For example, the user could select results for the year 2002 only, filtering this subset of data out of the cube.

This rich web-based user interface may sound similar to the SAP Query Builder, but it is focused on selecting a subset of data available from the query cube. The Query Builder is a much more complex system that defines query cubes. Once the query cubes in SAP have been defined to provide the needed data, the system can extract views of data, and present that to the user.

After an administrator completes configuration, the query can be executed, and the results are prepared for review. If the results contain the desired information, the administrator can move on to customizing the chart and publishing it in a web page.

The system enable an enterprise to visualize its information assets. A dashboard illustrates corporate performance and operation monitoring, including revenue growth, sales by product type, sales by representative, largest customers, and aging of receivables. Drill-downs were constructed so the user could examine the details in any of these areas. Such rich user interface would inform key management personnel of daily business operations, so they can adjust their short-term actions and develop their long-term strategy. It could also be published on the company's intranet to enhance collaboration between employees.

A dashboard can be easily created with the management system. The interface is formed from multiple tabs, each providing windows into operational or analytic data. For example, the design uses an automatic tab builder, or it could be built using HTML web pages. Each tab contains graphical components, which are based on data from extraction and transformation operations. With the proper data available, the graphical components were simply dragged into place. The Administrator can select chart types, colors, and other properties to highlight data resources. The final result is a business console to monitor business processes and improve decision making.

The system connect to SAP BW using its BW Adapter, and a Java API for BW access. The BW Adapter accesses BW through RFC, interfacing with the standard OLAP BAPI's and a custom FM, written in ABAP. Such BW Adapter is preferably certified by SAP.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A business system for data reporting and analysis, comprising:
a spreadsheet user interface located at a user site;
a web services API for supporting the spreadsheet user interface over the Internet; and
a business management system coupled to the web services API for collecting, analyzing, and publishing business data, and that allows users to visualize data using interactive charts, dashboards, and portals, and with a management system to extract, transform, and publish data, using intuitive wizards and menus, and including a transformation engine, which provides sophisticated data transforms through a menu interface, without relying on programming or scripting, and having a chart generation module to generate charts, graphs, and map graphics that can be customized using a WYSIWYG interface, and wherein business dashboards can be constructed through a drag-n-drop process, and further comprising an account management system with access control to protect information security.

2. The business system of claim 1, wherein:
the spreadsheet user interface includes a spreadsheet application program and a plug-in module for export and import of data and charts with the web services API.

3. The business system of claim 1, wherein:
the spreadsheet user interface includes an EXCEL spreadsheet application program and a plug-in module for export and import of data and charts with the web services API, such that a user can prepare data, publish data as charts and tables on web pages and dashboards, use data extractors, import data, and synchronize spreadsheet updates and dashboards.

4. The business system of claim 1, wherein the business management system further comprises:
a server-based extraction, transformation, and load (ETL) engine for extracting data from diverse sources including at least one of SAP BW, SAP Reports, SALESFORCE (SForce), SQL, XML, Excel, and plain text file sources, wherein data transforms are provides through a web-based menu interface and do not rely on programming or scripting, which can be expanded using a plug-in interface;
a client-based browser display for users to visualize said data, and to use interactive charts, dashboards, and portals;
intuitive wizards and menus in communication with a data management system for extracting, transforming, and publishing said data;
a POPCHART program to generate charts, graphs, and map graphics from said data;
a what-you-see-is-what-you-get (WYSIWYG) graphical user interface (GUI) for customizing said charts;
a drag-n-drop process for constructing business dashboards with access to said data;
a dashboard configuration system which supports any HTML template without modification;
a dashboard configuration system where web resources are available via WebDAV, where template and media changes are instantly shown in the published dashboard output; and
an account management system providing for user access control to protect information security related to said data.

5. The system of claim 1, further comprising:
an XE subsystem that provides for complex transformations which are defined on local system data, and that has been previously extracted from external data sources, and once source data is available, it is transformed, converted, formatted, or otherwise manipulated to a presentation form.

6. The system of claim 5, wherein:
The XE subsystem prepares data for presentation, and is not an analysis tool, and processes any number of XML definition files, e.g.,
<xe>
<transform name=“x” type=“y”>
<label>Sample Transform</label>
<description>Your average xform</description>
<parameter/>
...
<parameter name=“date-criteria” type=“date-criteria”>
<sql/>
</transform>
...
</xe>

7. The system of claim 5, wherein:
The XE subsystem extends said data management system, and provides a model transform, which operates on an entire data model, and series transforms, which are defined for each series in a data model; and
a set of transform labels can be loaded into a system user interface (UI) to make transforms available to the user, and a user interface interprets parameter metadata and generates a configuration user interface, and users can save transform configuration such that compilations of transformative SQL are based on user configuration and SQL template in an XE control file, and thereby subsequent execution of an SQL will produce a transformation.

8. A spreadsheet interfaced business system for data reporting and analysis, comprising:
an EXCEL spreadsheet and user interface located at a user site;
a web services API for supporting the spreadsheet user interface over the Internet;
a business management system coupled to the web services API for collecting, analyzing, and publishing business data, and that allows users to visualize data using interactive charts, dashboards, and portals, and with a management system to extract, transform, and publish data, using intuitive wizards and menus, and including a transformation engine, which provides sophisticated data transforms through a menu interface, without relying on programming or scripting, and having a chart generation module to generate charts, graphs, and map graphics that can be customized using a WYSIWYG interface, and wherein business dashboards can be constructed through a drag-n-drop process, and further comprising an account management system with access control to protect information security; and
an EXCEL plug-in module that includes a publishing wizard to select EXCEL data and publish it through the business management system, an extractor interface to select data objects from the business management system and import them to EXCEL, and a synchronizer to update the business management system when the EXCEL data changes.
